(19) United States
(12) Patent Application Publication
(10) Pub. No.: US 2010/0012758 A1
(43) Pub. Date: Jan. 21, 2010

(54) ZESTERS

(76) Inventors: Louis Chalfant, Hot Springs, AR (US); Carter W. McGuyer, Florence, AL (US); Christopher R. Grace, Russellville, AR (US)

Correspondence Address: LADAS & PARRY LLP, 224 SOUTH MICHIGAN AVENUE, SUITE 1600, CHICAGO, IL, 60604, US

(21) Appl. No.: 12/522,939

(22) PCT Filed: Sep. 12, 2007
(86) PCT No.: PCT/US07/19788

§ 371 Date: Jul. 13, 2009

(51) Int. Cl. A47J 43/25

(52) U.S. Cl. 241/95; 241/273.1; 241/168

(57) ABSTRACT

A kitchen utensil, in the nature of a zester (15), having a zester blade (17) on which an array of teeth are formed. The blade (17) is fashioned out of a blank of thin metallic material, the edges of which are quite sharp. At least two such edges intersect to create a very sharp point and which becomes an area of potential injury. To minimize injury at that intersection, and further, to protect counter tops and the like from marring and scratching, a-protective tip (40) is fitted over that intersection. The protective tip (40) is made out of a soft plastic or rubber material and inhibits contact with the point at that intersection and the area immediately adjacent thereto.

The present invention relates generally to kitchen utensils for performing a variety of tasks, such as grating or zesting citrus peel, hard spices such as cinnamon and garlic and the like, adding zest and aroma to various culinary preparations; with a focus here on safety in the use of a zester in a kitchen environment.

### BACKGROUND OF THE INVENTION

1. Field of the Invention

The zester, sometimes referred to as a grater, has existed in the kitchen, be it commercial or residential, for many years, permitting chefs to accent their creations by zesting such flavors as citrus and hard spices, such as cloves and garlic, just to name a few. Whereas a grater is used to reduce the size of a food stuff such as cheese into a more manageable size, the zester is used to penetrate the surface of an object, e.g., the surface of an orange or lemon, to create a sliver in the nature of a shaving, thereby releasing aromas and zesty flavors which enhance the dish being prepared.

2. Overview of the Prior Art

Zesters come in several shapes and sizes. Some have handles and others do not. Many provide shields, or covers, to prevent injury during storage when not in use, but seldom does one provide protection for both users and counter tops during use.

There is one characteristic that is common to all zesters and that is an array of very sharp teeth formed in a piece of metal, itself having very sharp edges. Both of these factors necessitate handling of a zester with some considerable care. Despite the rather obvious nature of the potential for scrapes and cuts, a user, whether because of great familiarity with the utensil or haste in its use, often ends up with minor, but irritating injuries. Moreover, counter tops and other kitchen surfaces end up marred and scratched by the sharp edges and corners inherent in the instrument.

### SUMMARY OF THE INVENTION

In recognition of the potential for injury in the use of zesters, it is a primary objective of the present invention to eliminate, insofar as possible, some of the cuts and scrapes which might be encountered as a consequence of inadvertence or carelessness in use or handling.

It is another, yet related objective, to enhance the popularity and usage of a zester, by making its use less susceptible to injury to both the user and the surrounding kitchen surfaces.

The foregoing, as well as other objectives and advantages of the present invention, will become more evident to those skilled in the art from a reading of the forthcoming Detailed Description of a Preferred Embodiment, taken in conjunction with the accompanying drawings, wherein:

### BRIEF DESCRIPTION F THE DRAWINGS

FIG. 1 is a pictorial view of a zester with a blade guard attachment and a handle included and with protective buttons, constructed in accordance with the present invention, in place on the blade;

FIG. 2 is a pictorial view of the protective tip, or button, of FIG. 1;

FIG. 3 is a side elevation of the protective tip of FIG. 2;

FIG. 4 is an end view of the protective tip of FIG. 2;

FIG. 5 is perspective view, partially sectioned, of the free end of the zester blade, with an end of a protective shield aligned for insertion into its protective position on the blade;

FIG. 6 is an end view of the free end of the zester blade with the protective shield in place;

FIG. 7 is a pictorial representation of a user zesting a cinnamon stick; and,

FIG. 8 is a side elevation of the activity depicted in FIG. 7, illustrating the angle at which the zester may be used to accomplish the zesting of a foodstuff.

### DESCRIPTION OF A PREFERRED EMBODIMENT

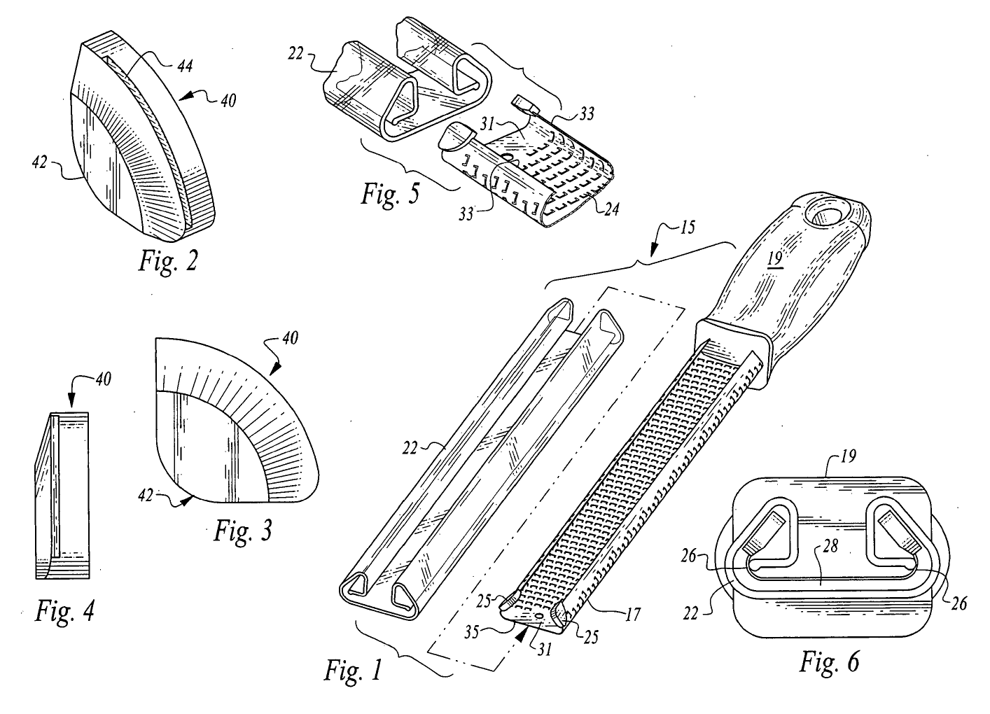

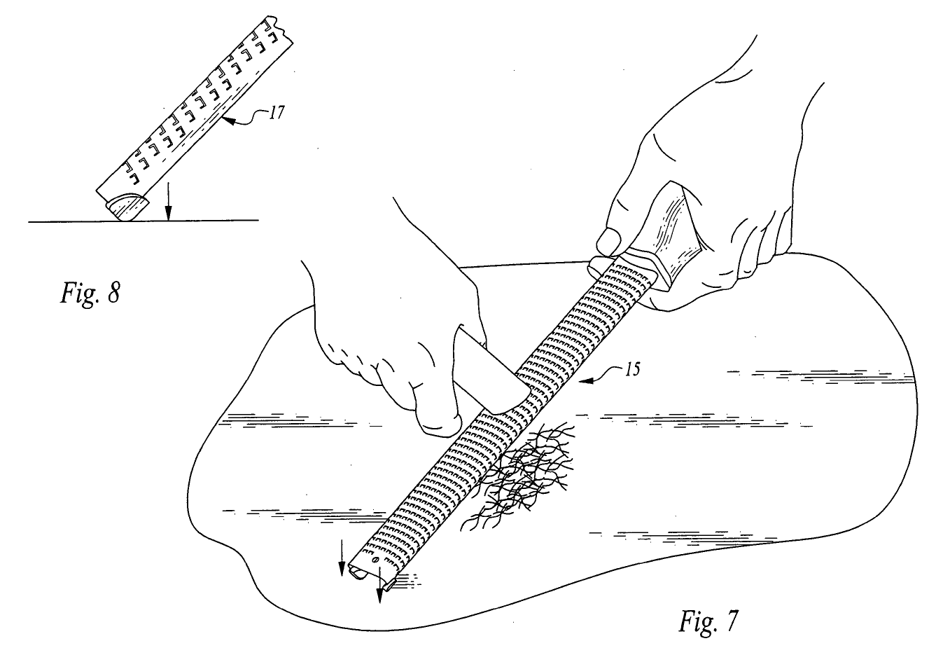

With reference now to the drawings, and initially to FIG. 1, a representative zester 15, constructed in accordance with the present invention is illustrated. The zester 15 comprises a zester blade 17 formed of a blank of thin metallic material and is supported in an ergonomically designed handle 19. A blade guard 22 may also be provided and is so formed as to slide snugly over the blade 17 so as to protect the several sharp edges from inadvertent contact with a user.

The zester blade 17 is the heart of the instrument. As illustrated, the blade 17 comprises an elongate strip of stainless steel or like material. The blade is provided with an array of teeth 24, preferably formed by a photo chemical process as taught by Sturtevant et al., U.S. Pat. No. 5,100,506. It will be appreciated that the shape of the zester blade and the specific method of forming the teeth on the blade of a zester is a matter of choice and are within the contemplation of the invention.

The blank from which the blade 17 is fashioned, is shaped over a suitable die to create inwardly facing wings flanking a central strip 28. The blade shield 22 is formed of a relatively pliable plastic material which slides over the free end of the blade and snugly fits about the blade, protecting the several sharp edges of the blade during storage, and is best viewed in FIG. 6.

As is well known to users of zesters, the blade has very sharp edges, at least two of which inevitably intersect to define very pointed and sharp corners, in addition to the teeth, and users are vulnerable to inadvertent cuts and scrapes during use, despite all attempts at caution. While the injuries are primarily minor in nature, the potential for such injures tends to inhibit the free use of such utensils. Similarly, counter tops and like surfaces are susceptible to marring and scratching, which leaves an unsightly mess that can not be easily wiped away, and that contributes to any hesitance which a potential user might have in employing an otherwise very useful kitchen utensil.

Perhaps one of the more vulnerable areas of the blade is found at the free end 31 of the blade at the corners 25 of the wings 26. Those corners are at the intersection of an elongated sharp edge 33 and the transverse sharp leading edge 35, and both of those edges are extremely sharp. In order to protect a user, as well as working surfaces, and reduce potential injuries to either or both during use, the present invention contemplates the use of a protective tip in the nature of button 40.

The protective tip, or button 40, as shown, is formed of an elastomeric material which may be rubber or plastic material. The button has a smooth circular shaped outer wall 42, although the precise shape is not considered critical to the safety issue. A slot 44 [FIG. 2] is formed in the button 40 to grippingly receive the sharp corners 25 of the blade 17. The slot preferably provides for approximately the same thickness of material on either side thereof. Where deemed advisable, adhesives may be used to secure the buttons in position on the corners 25. It is preferable that the button be sufficiently thick as to provide necessary protection, while avoiding a size that would inhibit storage in a blade guard. Additionally, the size of the buttons, which is considerably more thick than the blade itself, will hold the blade away from the counter top or cutting board which supports the food stuff being zested, and the surface which supports the zester when temporarily laid aside.

It will now appear that with the buttons 40 firmly in place, a major area for potential injury to the user, and to a working surface, has been rendered neutral, and, as a result, the zester has become more safe and for those who, in earlier times, have been inhibited by the potential for injury, are relieved of that concern.

It will now be appreciated that while the present invention has been described within a particular environment, the principals are easily adapted to a variety of zester structures, and the specific form of the protective tip may vary to accommodate specific structures, all within the purview of the invention as described and claimed as follows.

1. A zester for removing small portions of the surface of citrus and hard spices in order to enhance particular culinary preparations;
said zester including a zester blade, said blade being formed from a blank of metal, said blank having an array of sharp teeth formed thereon;
said blank having at least two intersecting edges about the periphery thereof;
a protective tip at each said intersection of said intersecting edges, encasing said edges at said intersection to protect against inadvertent scrapes and cuts at and about said intersection of said edges.

2. The zester of claim 1, wherein said teeth on said zester blade being formed by a photochemical process.

3. The zester of claim 1, wherein said protective tip is formed of an elastomeric material.

4. The zester of claim 1, wherein said protective tip is formed with a slot, said slot adapted to encase intersecting edges so as to protect users of the zester from injuries resulting from coming in contact with said intersecting edges.

5. The zester of claim 4, wherein said protective tip is held in position encasing said intersecting edges by means of an adhesive contained in said slot.

6. The zester of claim 2, wherein said protective tip is formed with a slot, said slot adapted to encase intersecting edges so as to protect users of the zester from injuries resulting from coming in contact with said intersecting edges.

7. The zester of claim 3, wherein said protective tip is formed with a slot, said slot adapted to encase intersecting edges so as to protect users of the zester from injuries resulting from coming in contact with said intersecting edges.

8. The zester of claim 7, wherein said protective tip is held in position encasing said intersecting edges by means of an adhesive contained in said slot.

9. The zester of claim 2, wherein said protective tip is formed with a slot, said slot adapted to encase intersecting edges so as to protect users of the zester from injuries resulting from coming in contact with said intersecting edges.

10. The zester of claim 2, wherein said protective tip is held in position encasing said intersecting edges by means of an adhesive contained in said slot.

11. The zester of claim 1, wherein said protective tip has a smooth circular shaped outer wall.
